(19) United States
(12) Patent Application Publication
(10) Pub. No.: US 2014/0354973 A1
(43) Pub. Date: Dec. 4, 2014

(54) Structural health monitoring method and apparatus based on optical fiber bend loss measurement

(71) Applicants: XUEKANG SHAN, SAN DIEGO, CA (US); JIN HAO, SAN DIEGO, CA (US); RUNBAO HAO, JIN ZHONG (CN)

(72) Inventors: XUEKANG SHAN, SAN DIEGO, CA (US); JIN HAO, SAN DIEGO, CA (US); RUNBAO HAO, JIN ZHONG (CN)

(21) Appl. No.: 13/907,964

(22) Filed: Jun. 2, 2013

(51) Int. Cl. G01L 1/24

(52) U.S. Cl. CPC G01L 1/242
USPC 356/32

(57) ABSTRACT

A fiber optic strain sensor, an optical pulse generator generates an initial optical pulse, and launches it into an optical fiber-optical strain probe chain through an optical circulator. The scattered optical power in the optical fiber and optical strain probe chain is sent to an optical receiver, also via the optical circulator. The optical strain probes are attached to a structure whose strain is to be measured. Strain in the structure causes the fiber bend loss to change in the strain probe, and causes the scattered optical power received by the optical receiver to change accordingly. From the change of the output of the optical receiver and the time required for the scattered optical power to travel from the probe, the strain at each of the probes is calculated.

### BACKGROUND OF THE INVENTION

Timely and accurate detection of structural cracking, deformation, displacement and other damages is essential for the safe operation of many structures, such as bridges, dams, tunnels, tall buildings, etc. Various types of sensors have been developed and deployed to monitor structures. Electric strain gauges are widely used. These gauges change resistance when subjected to deformation. This type of strain sensor is low cost itself and easy to install, if only a small number is needed. However, to monitor a large structure, e.g., a bridge, tens or even hundreds are needed, and the installation, especially wiring, becomes highly complicated and costly.

In the past 20 years or so, with the advance of optical fiber technology, fiber optic methods for structural health monitoring have been developed. Compared to their conventional counterparts, fiber optic based structural health monitoring systems have the advantages of high sensitivity, multi-point or distributed monitoring, immunity to electro magnetic interference, and ease of deployment.

Amongst fiber optic structural health monitoring methods, two technologies have received wide attention: 1. fiber Bragg grating (FBG) based sensors; 2. Brillouin distributed fiber strain and temperature sensors. Fiber Bragg gratings can be written into single mode fibers, and as a result, these fibers will reflect light at the Bragg wavelength. Stretching a fiber with Bragg grating in it changes the grating period and thus the reflected wavelength. This is the principle of the FBG based strain sensor. A number of FBGs with different Bragg wavelengths can be concatenated to form a multi-point strain sensor, and a FBG interrogator measures the changes of the reflected wavelengths, and then the strains at these points can be calculated. Since FBGs are only a few millimeters in size, this type of sensors can have very high spacial resolution of a few centimeters. Up to a few tens of FBGs can be concatenated in a single fiber line to make a quasi distributed sensor. However, FBGs are sensitive to temperature as well, and distinguishing if wavelength changes are caused by strain or by temperature makes the system complex.

Brillouin strain sensor is based on Brillouin scattering in optical fibers. Brillouin scattering in optical fibers is a backward scattering of optical power due to the interaction of light with acoustic phonons propagating in the fiber core. The Brillouin scattered light has a frequency shift which is proportional to the local velocity of the acoustic phonons. This velocity depends on the material density and tension, and thus on the temperature and strain. This type of sensors can achieve up to 1 meter spacial resolution, and up to a few tens of km range. This type of strain sensors are generally complex and expensive, and have not been widely deployed.

Apparently, low cost, easy to deploy structural health monitors are still expected.

### SUMMERY OF THE INVENTION

This invention provides a fiber optic strain sensor. An optical pulse generator launches an optical pulse into an optical fiber-optical strain probe chain, and the scattered optical power is sent to an optical receiver. The optical strain probe is a length of optical fiber wound on a frame, which is attached to the structure whose strain is to be monitored. The frame changes shape when subjected to external strain such that the optical fiber wound on it experiences bend loss change. The optical receiver detects the corresponding change in scattered optical power, and a signal processing unit calculates the strain in the structure that causes the optical power change.

### BRIEF DESCRIPTION OF THE DRAWINGS

FIG. 1 shows bending loss versus bending radius in an optical fiber.

FIG. 2 shows the preferred embodiment of the present invention.

FIG. 3 shows a type of fiber optic strain probe based on fiber bending loss.

FIG. 4 shows another type of strain probe based on fiber bending loss.

FIG. 5 shows yest another type of strain probe based on fiber bending loss.

FIG. 6 shows a multi-channel structural strain sensor based on fiber bending loss.

### DETAILED DESCRIPTION OF THE PREFERRED EMBODIMENT

This invention is based on the measurement of optical fiber bending loss which is varied by the strain being monitored.

It is well known that bending causes loss in optical fibers and that useful signal power is thus reduced. In sensor applications, however, this bending loss can be utilized to its benefits. If a physical variable is able to change the fiber bending loss, measurement of this loss then can be used to determine this physical variable.

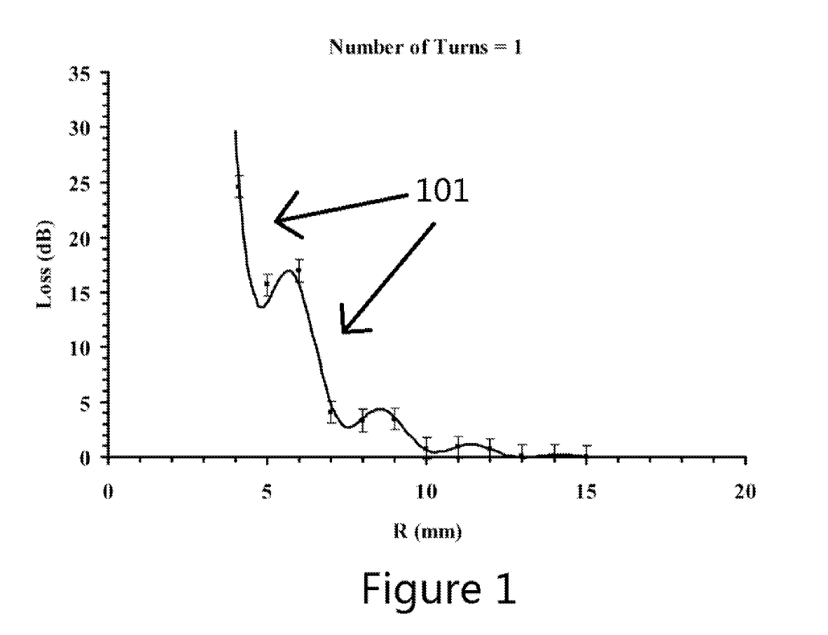

The bending loss of a given single-mode optical fiber is a function of wavelength and bending radius. At a given wavelength, the bending loss only depends on bending radius, as is shown in FIG. 1.

Optical fiber bending loss L can be expressed as:

$$L = 5 {F}_{1} ( 5 {F}_{2} + {F}_{3} )$$

$$Where \text{:}$$

$${F}_{1} = 2.79 exp ( - \frac{{R}_{eff}}{3} )$$

$${F}_{2} = - 1.29 {J}_{1} ( 2.25 {R}_{eff} )$$

$${F}_{3} = 12.05 exp ( - \frac{{R}_{eff}}{5} )$$

Where J₁ is the Bessel function of first order, and Reff=R−0.8. (R is the actual bending radius)

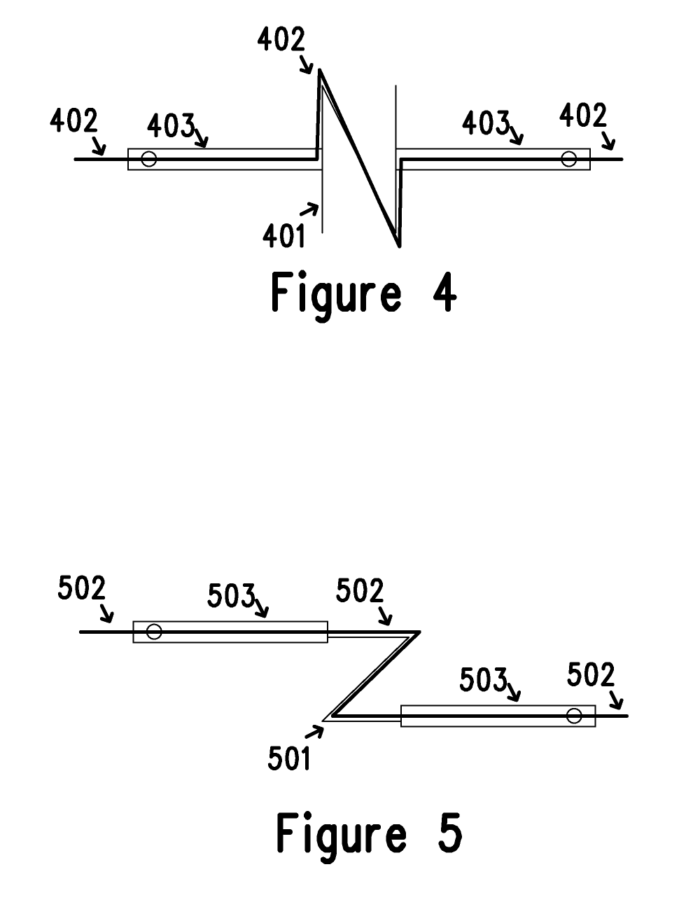

In order to translate changes of the structural strain into changes of fiber bending loss, a length of optical fiber is wound on an specially designed frame. One form of this type of frame 301 is ovally shaped. The ovally shaped frame is connected to an extension rod 303 on each side, and the two rods are attached to the structure whose strain is to be measured. When the strain in the structure changes, the two rods move towards each other or further apart, and the ovally shaped frame is squeezed or stretched. As a result, the curvature at the two pointed ends of the frame shrink or expand. Because the fiber is wound on the frame, the bend loss of the fiber changes accordingly. Other frame shapes can also be used to achieve similar effect. Some examples are shown in FIG. 4 and FIG. 5. FIG. 4 shows horizontally Z shaped frame 401. It has an extension rod 403 on each side, and an optical fiber 402 is attached to it. FIG. 5 shows vertically Z shaped frame 501 with extension rods 503 and optical fiber 502. In principle, any frame shape, that translates linear movement to change in the curvature of part of the frame, can be used as the probe frame.

It can be seen in FIG. 1 that the fiber bending loss curve exhibits some oscillation when the bending radius approaches zero. To avoid any ambiguity in measured bending loss as a function of bending radius, the probe is designed to work in a linear section 101 of the curve.

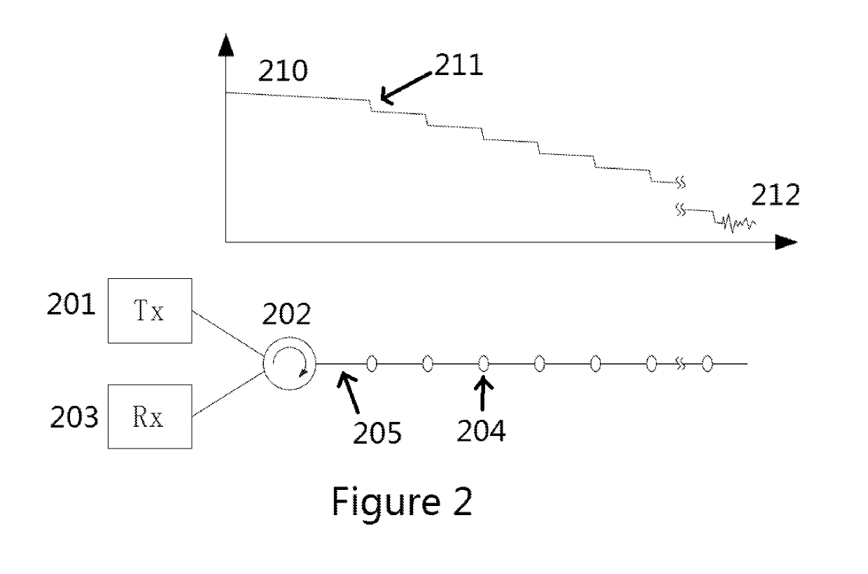

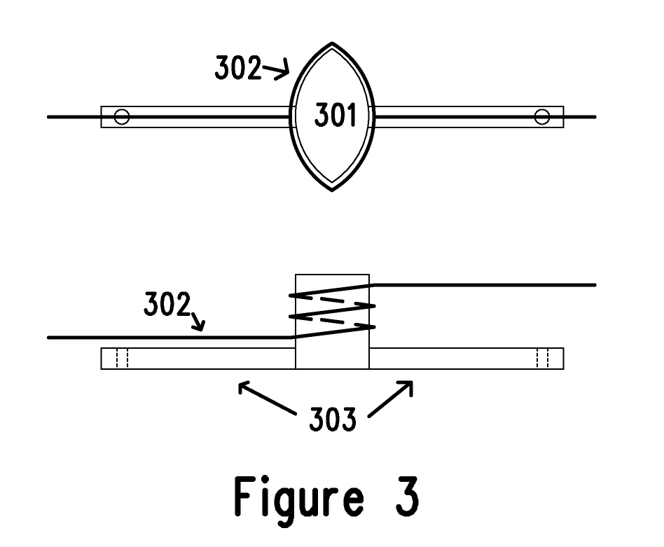

As is shown in FIG. 2, a number of such probes 205 are concatenated with optical fibers 205 in between to form an optical probe chain, and the probes are attached to the structure to be monitored. The optical transmitter 201 is basically a pulsed laser that launches an optical pulse into the fiber, and the back scattered optical power is detected by an optical receiver 203 via an optical circulator 202. By measuring the arrival time and the magnitude of the returning signal in the electrical output of the optical receiver, the optical attenuation along the optical path is calculated by the signal processing unit, and the strain in the structure is thus measured. To suppress noise in the circuitry, multiple optical pulses are launched and the received signal is averaged.

The sensitivity of the strain probe can be adjusted by:

1. Changing the number of turns of optical fiber wound on the frame. The larger number of turns, the higher the sensitivity;

2. Changing the effective length of the extension arms. The longer the arms, the higher the sensitivity. The effective length can be adjusted by using different holes on the arms for fixing the probe to the structure.

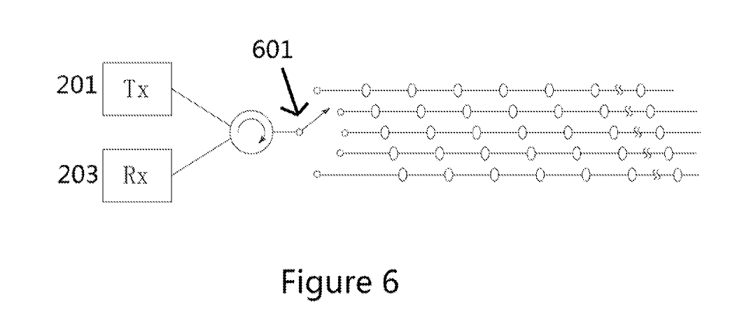

The optical pulse normally has a temporal width of a few to a few tens of nano-seconds. Therefore, the spatial resolution of the strain sensor is normally a few meters. That is, if any two optical probes are installed only a few meters apart, the strain sensor will not be able to temporally resolve the detected strain. In practice, there might be situations where a long working range and a high spatial resolution are required at the same time. To meet such requirements, a multi-channel time domain multiplex sensor system can be used (FIG. 6). An optical switch (601) connects the optical transmitter 201/receiver 203 to each of the optical probe chains in turn. The optical probes in each probe chain are placed such that the probe spacing in any one chain is larger than the sensor resolution and the offset between probe chains makes the physical separation of probes in different chains is as small as is required for a quasi distributed strain sensing system.

The maximum number of strain probes that can be included in one fiber-probe chain is limited by the maximum optical loss in the fiber and the probes, and the circuit noise in the optical receiver. As is shown in FIG. 1 the received optical power 210 gradually reduces along the chain and there is a sharp drop 211 at each probe. Finally, the power level lowers to the receiver noise floor 212, and this sets the limit of the maximum number of probes that can be included in the chain.

The materials that form the structure under monitoring have thermal expansion. which leads to temperature sensitivity of in the strain probe. Strain measurement is thus interfered by temperature effects. To minimize this temperature sensitivity, the materials to make the strain probe are selected to match the thermal expansion of the structure. The most common material for large structures such as bridges, dams, tunnels, is steel reinforced concrete, which has a thermal expansion coefficient essentially the same as that of steel. Therefore it is easy to select a material for the rods on the probe that matches thermal expansion of the structure under monitoring.

What is claimed is:

1. An optical strain sensor comprising:
A) an optical signal generator for launching an initial optical pulse into optical fibers;
B) multiple optical strain probes that are based on optical fiber macro bend loss and that are concatenated by said optical fibers to form an optical probe chain;
C) an optical receiver that receives optical power scattered back from the optical strain probes and the optical fibers connecting them and that converts received optical signal into electric signal;
D) a digital signal procession unit for calculating changes of optical loss at each of said optical strain probes

2. The optical strain sensor as in claim 1, wherein said optical signal generator is an optical short pulse transmitter and said generated signal is an optical pulse.

3. The optical strain sensor as in claim 1, wherein said optical strain probe comprises a length of optical fiber wound on an ovally shaped frame wherein strain in a structure under measurement changes the curvature of said ovally shaped frame through two extension rods that are fixed on said structure.

4. The optical strain sensor as in claim 1, wherein said optical probes whose sensitivity can be adjusted by changing the number of turns of said optical fiber wound on said ovally shaped frame, or by changing the length of said extension rods connected to said ovally shaped frame.

5. The optical strain sensor as in claim 1, wherein said signal processing unit calculates the strain at each of said optical probes by measuring the scattered optical power drop at said optical probe.

6. The optical strain sensor as in claim 1, wherein said optical probes whose temperature sensitivity is minimized by selecting a material that has a similar thermal expansion coefficient as that of the structure under monitoring.

7. The optical strain sensor as in claim 1, wherein multiple said optical probe chains are used and an optical switch selects one of said optical probe chains in turn to be connected to said optical pulse generator and said optical receiver to form an optical strain sensor with a high spatial resolution and a large operating range.
